(19) United States
(12) Patent Application Publication
(10) Pub. No.: US 2024/0184649 A1
(43) Pub. Date: Jun. 6, 2024

(54) REAL-TIME CONSTRAINTS FOR ASYNCHRONOUS COMMUNICATIONS

(71) Applicant: Salesforce, Inc., San Francisco, CA (US)

(72) Inventor: Anurodh Pokharel, Brookline, MA (US)

(73) Assignee: Salesforce, Inc., San Francisco, CA (US)

(21) Appl. No.: 18/074,345

(22) Filed: Dec. 2, 2022

(51) Int. Cl. G06F 9/54; G06F 11/14

(52) U.S. Cl. CPC G06F 9/546; G06F 11/1448

(57) ABSTRACT

Methods, systems, and storage media are described for real-time constraints for asynchronous message delivery. In particular, some implementations are directed to real-time constraints contained in the metadata of messages. Other implementations may be disclosed or claimed.

### TECHNICAL FIELD

Some implementations disclosed herein are directed to real-time constraints for asynchronous message delivery. In particular, some implementations are directed to real-time constraints contained in the metadata of messages.

### BACKGROUND

In conventional systems, for messages transmitted asynchronously, (e.g., passed through stacks of systems operating in distributed locations with independent queues such as micro services), there is no guarantee a particular message will arrive before after another message. Additionally, a delivery system that goes offline or is otherwise disconnected may have a queue of messages that it will try to deliver regardless of the current relevance of such message. Implementations of the present disclosure address these and other issues.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a functional block diagram illustrating an example of a system providing real-time constraints for asynchronous communications in accordance with various implementations.

FIG. 2, FIG. 3, and FIG. 4 illustrate examples of data structures that may be used to indicate real-time delivery constraints in accordance with various implementations

FIG. 5 is a flow diagram illustrating an example of a process for providing real-time constraints for asynchronous communications in accordance with various implementations.

FIG. 6A is a block diagram illustrating an electronic device in accordance with various implementations.

FIG. 6B is a block diagram of a deployment environment in accordance with various implementations.

### DETAILED DESCRIPTION

As introduced above, in conventional systems there often is no guarantee that a particular asynchronous message will arrive at its destination before after another asynchronously-transmitted message. Likewise, queues of messages associated with delivery systems that go offline or are otherwise disconnected may still be delivered, regardless of their current relevance.

Implementations of the present disclosure address these and other issues by using real-time constraints contained in the messages themselves (e.g., in metadata). For example, messages may contain metadata to flag themselves as expiring after a predetermined time (referred to herein as a “soft” real-time constraint), or to flag the message to expire if it would be delivered after another message in a sequence (referred to herein as a “hard” real-time constraint).

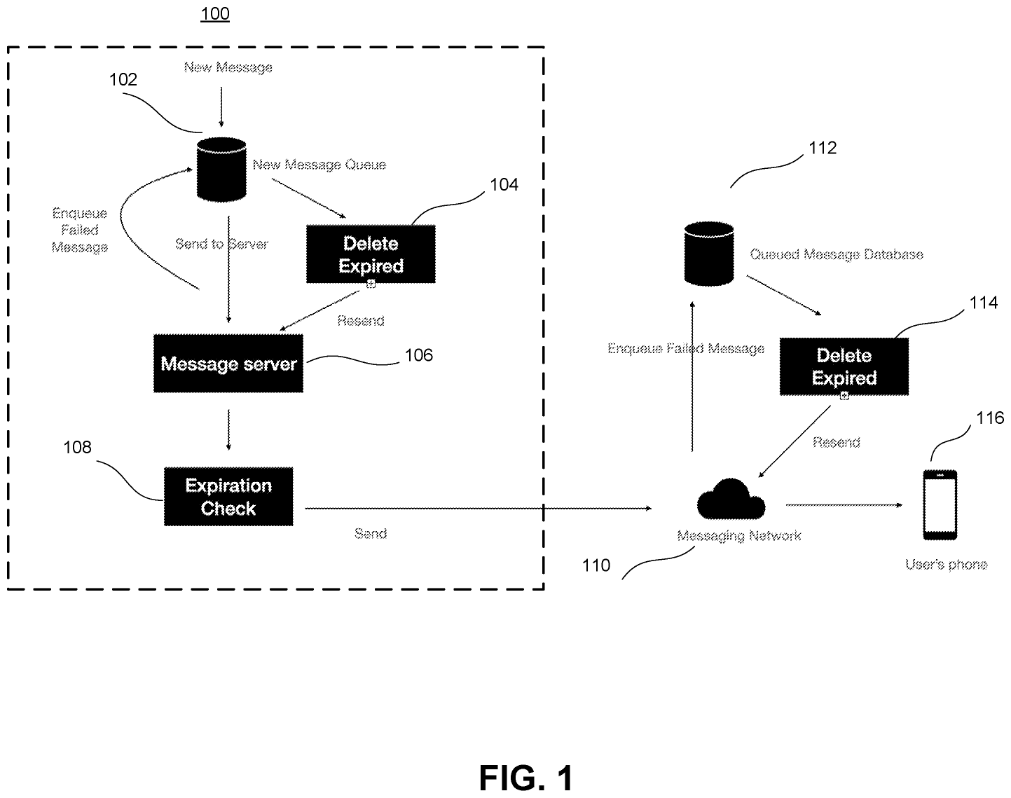

FIG. 1 is a functional block diagram illustrating an example of a system providing real-time constraints for asynchronous communications in accordance with various implementations. In this example, messaging system 100 includes a new message queue 102 and a message server 106. New messages arriving in the messaging system 100 are added to the new message queue 102 for transmission by the message server.

Similarly, messages that fail to transmit (e.g., due to hardware failures or network connection loss) are added to the new message queue 102 for later transmission by the message server 106. For example, when there is a hardware failure or a network loss associated with the messaging system 100 (and assuming the data is not lost) when the system 100 (or portion thereof) is brought back online it needs to send out any queued messages. Implementations of the present disclosure help provide experience and performance improvements by deleting messages that are expired/irrelevant and only transmitting those message that are still relevant.

At 104 and 108, the system 100 determines whether an enqueued message is expired (and if so, deleted) or should be resent by the message server 106. Messages that pass the expiration check and are deemed to still be relevant for transmission are sent by the messaging system 100 to a messaging network 110 for transmission to a user's computing device 116.

In this example, the messaging network 110 may implement features of the present disclosure similar to the messaging system 100. For example, messages that fail to transmit from the messaging network 110 to the user's device 116 are added to the queued message database 112. At 114, the messaging network determines whether an enqueued message is expired (and if so, the message is deleted). Otherwise, the messaging network 110 resends the enqueued message to the user's computing device 116.

In this manner, stale/irrelevant messages are quickly identified and can be skipped. In some implementations, the message server 106 may perform a database query on startup to delete all stale/irrelevant messages in the message queue 102. For example, the query could delete from messages where (type=soft or type=hard+soft) and timestamp+window>now( ).

The implementations of the present disclosure thus allow the system 100 to quickly focus on messages that are still relevant. Assuming that sending each message in the queue to the messaging network 110 (e.g. sms, Facebook, etc.) is the slowest operation, then (at the very least) under normal circumstances iterating and sending out every message that was queued up during an outage/interruption would take time of O(n) where n is the number of messages. Assuming further that the message queue 102 has an indexed table, the message server 106 can quickly delete batches of stale/irrelevant messages to provide a performance of the system that is faster than O(n).

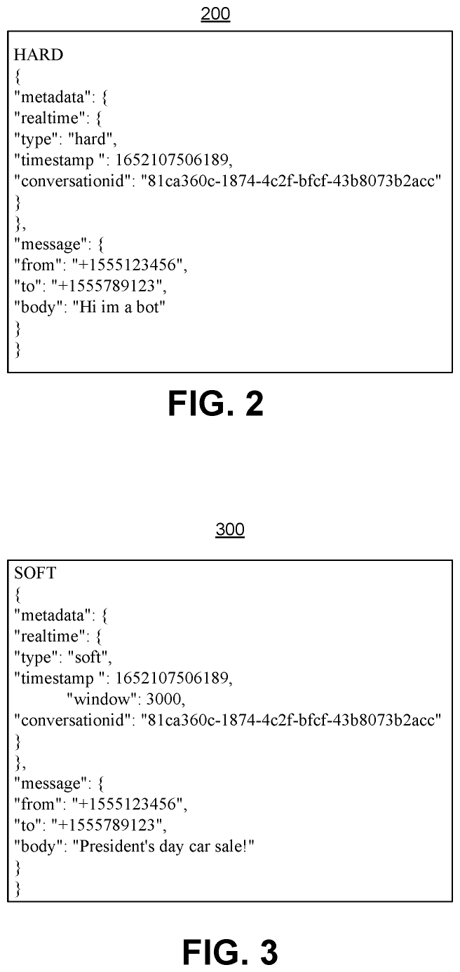

FIG. 2. FIG. 3, and FIG. 4 illustrate examples of data structures that may be used to indicate real-time delivery constraints in accordance with various implementations. In various implementations, these data structures may be included in the metadata of a message, added to a header of the message, or otherwise included in any suitable portion of the message to indicate a real-time delivery constraint. A message delivery system (such as messaging system 100 or messaging network 110 in FIG. 1) may retrieve the real-time delivery constraint information in the data structure in order to determine whether a queued message should be deleted or sent. In some implementations, some messages may include real-time delivery constraints while others do not, such that messages without the real-time delivery constraints may be queued and delivered in a conventional manner.

In FIG. 2, data structure 200 includes a “hard” type field to indicate that the message is associated with a “hard” real-time delivery constraint, as well as a timestamp field. As used herein, a hard real-time delivery constraint is a constraint based on a hard (binary) determination of whether the current time is after the timestamp. If the current time is after the timestamp, the message would be dropped since it is no longer relevant if the real time deadline indicated by the timestamp is missed. If the current time is before (or optionally at) the timestamp, the message may be encoded for delivery/redelivery to the user's computing device.

An example of a message that may have a hard real-time delivery constraint is a typing notification message. The notification message should never be delivered after the message that was being typed is delivered because doing so would result in a confusing scenario where the user sees a “ . . . ” typing notification and expects a message to arrive, but the message was already delivered. In another example, in bot a conversation, an introductory message such as “hello” should always arrive before a subsequent one that has more info. As with the example of the notification message, an introductory message that arrives after the informational message is confusing to a user and provides a bad user experience.

In cases where the hard real-time delivery constraint indicates the message is no longer valid/relevant, the system may drop (e.g., delete) the irrelevant message rather than have the message show up in the middle of a conversation or otherwise in a confusing out-of-sequence manner.

FIG. 3 illustrates an example of a data structure 300 includes a “soft” type field to indicate that the message is associated with a “soft” real-time delivery constraint. The data structure 300 further includes a timestamp field, as well as a time window field associated with the timestamp beyond which the message is not relevant. In this example, the message may be encoded for delivery/redelivery to a user's computing device if the current time is within the time window, and the message is deleted as expired in response to the current time being beyond the time window.

An example of a message that may include a soft real-time delivery constraint includes a holiday or event greeting message or a sale promotion. For example, some greetings (such as a birthday greeting) should never be delivered before a date/time indicated by a timestamp (e.g., the birthday) but can be delivered within a predetermined time window after the timestamp (e.g., any time during the actual day of the person's birthday). In other cases, the window may specify that a message can be delivered within a window up to the timestamp, but should never be delivered after the timestamp.

In data structure 300, for example, the message corresponds to a promotion for a “President's day car sale.” In this example, the timestamp and time window may allow the promotion message to be sent up to and including President's day, but afterwards the message would be deemed irrelevant and dropped/deleted as being expired.

In another soft real-time message example, a Valentine's day greeting may only be relevant for the duration of February 14 of that year for delivery. After that window, the message should be dropped/deleted as being expired.

In some implementations, a message may include multiple hard and/or soft real-time delivery constraints. In such cases, a message may be delivered if any of the constraints are relevant at the time the message is to be delivered, or deleted as irrelevant if all constraints are currently invalid.

FIG. 4 illustrates an example of a data structure 400 that includes both a hard real-time delivery constraint and a soft real-time delivery constraint. In this example, data structure 400 includes a timestamp after which the message is not relevant relative to the hard real-time delivery constraint. The data structure 400 further includes a time window associated with the timestamp, and the message is not relevant relative to the soft real-time delivery constraint beyond the time window.

In this example, a message comprising data structure 400 may be deleted/dropped as expired in response to the current time being both after the timestamp (thus irrelevant relative to the hard constraint) and beyond the time window (thus irrelevant relative to the soft constraint). Otherwise, if the message is still relevant relative to either the hard constraint (the current time is before or at the timestamp) or the soft constraint (the current time is within the time window), the message may be delivered.

In various implementations, the data structures (or other portions of the message) may include any other suitable fields and information beyond the information associated with the real-time delivery constraint(s). For example, as illustrated in data structures 200, 300, and 400, the message may include an identifier associated with the user or the user's computing device, as well as an identifier associated with a source of the message (e.g., another user or device).

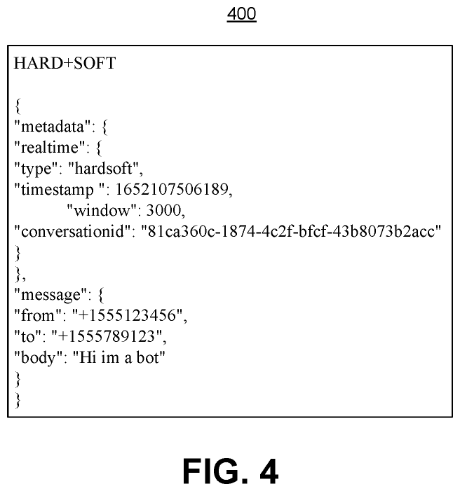

FIG. 5 is a flow diagram illustrating an example of a process that provides real-time constraints for real-time communications in accordance with various implementations. In some implementations, process 200 may be performed any suitable system or device (or portion thereof), such as the messaging system 100 in FIG. 1 or the systems illustrated in FIGS. 3A and 3B. In this example, process 500 includes, at 505, retrieving a message from a message queue, the message being associated with a hard real-time delivery constraint or a soft real-time delivery constraint. The process further includes, at 510, determining a current relevance of the message based on the message being associated with the soft real-time delivery constraint or the hard real-time delivery constraint. The process further includes, at 515, based on the determined current relevance of the message, either: deleting the message as being expired; or encoding the message for delivery to a user's computing device. In some implementations, as illustrated in FIG. 1, the message may be encoded for delivery to a user's computing device via a messaging system (such as messaging system 100) as well as via a messaging network (such as messaging network 110).

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### Electronic Devices and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM). Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios. “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

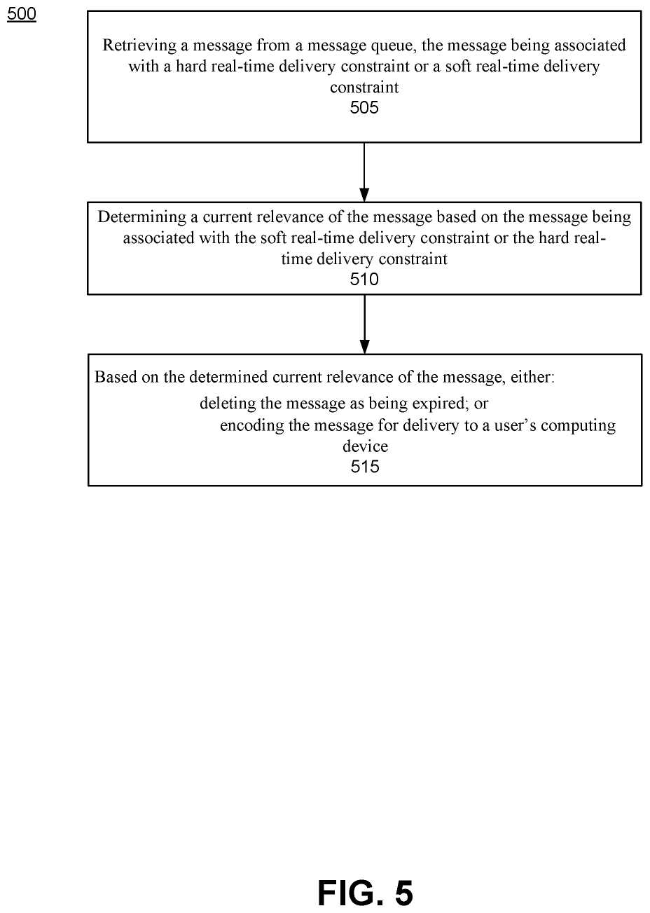

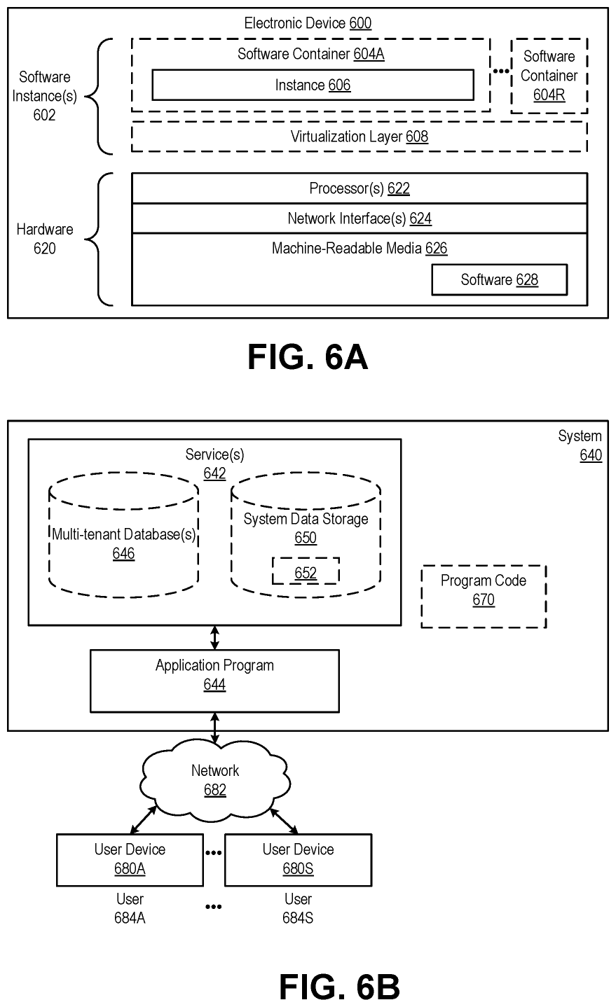

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media. Each of the previously described clients and the network protocol for extending a trust boundary between cloud domains of the same entity may be implemented in one or more electronic devices 600. In one implementation: 1) each of the clients is implemented in a separate one of the electronic devices 600 (e.g., in end user devices where the software 628 represents the software to implement clients to interface directly and/or indirectly with the network protocol for extending a trust boundary between cloud domains of the same entity (e.g., software 628 represents a web browser, a native client, a portal, a command-line interface, and/or an application programming interface (API) based upon protocols such as Simple Object Access Protocol (SOAP). Representational State Transfer (REST), etc.)); 2) the network protocol for extending a trust boundary between cloud domains of the same entity is implemented in a separate set of one or more of the electronic devices 600 (e.g., a set of one or more server devices where the software 628 represents the software to implement the network protocol for extending a trust boundary between cloud domains of the same entity); and 3) in operation, the electronic devices implementing the clients and the network protocol for extending a trust boundary between cloud domains of the same entity would be communicatively coupled (e.g., by a network) and would establish between them (or through one or more other layers and/or or other services) connections for submitting configuration data to the network protocol for extending a trust boundary between cloud domains of the same entity and returning a software package to the clients. Other configurations of electronic devices may be used in other implementations (e.g., an implementation in which the client and the network protocol for extending a trust boundary between cloud domains of the same entity are implemented on a single one of electronic device 600).

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-604R (e.g., with operating system-level virtualization, the virtualization layer 608 may represent a container engine (such as Docker Engine by Docker. Inc. or rkt in Container Linux by Red Hat. Inc.) running on top of (or integrated into) an operating system, and it allows for the creation of multiple software containers 604A-604R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-604R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-604R if implemented, are collectively referred to as software instance(s) 602.

Alternative implementations of an electronic device may have numerous variations from that described above. For example, customized hardware and/or accelerators might also be used in an electronic device.

### Environment Example

FIG. 6B is a block diagram of a deployment environment according to some example implementations. A system 640 includes hardware (e.g., a set of one or more server devices) and software to provide service(s) 642, including services associated with the implementations described herein. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon.com, Inc. (Amazon Web Services), Google LLC (Google Cloud Platform (GCP)), Microsoft Corporation (Azure)).

The system 640 is coupled to user devices 680A-680S over a network 682. The service(s) 642 may be on-demand services that are made available to one or more of the users 684A-684S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-684S). The service(s) 642 may communicate with each other and/or with one or more of the user devices 680A-680S via one or more APIs (e.g., a REST API). In some implementations, the user devices 680A-680S are operated by users 684A-684S, and each may be operated as a client device and/or a server device. In some implementations, one or more of the user devices 680A-680S are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 640 is a multi-tenant cloud computing architecture supporting multiple services, such as one or more of the following types of services; Self-Healing Build Pipeline service 642; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 640 may include an application platform 644 that enables PAAS for creating, managing, and executing one or more applications developed by the provider of the application platform 644, users accessing the system 640 via one or more of user devices 680A-680S, or third-party application developers accessing the system 640 via one or more of user devices 680A-680S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user devices 680A-680S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the multi-tenant database(s) 646 and/or system data storage 650.

In some implementations, the service(s) 642 are implemented using virtual applications dynamically created at run time responsive to queries from the user devices 680A-680S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 670 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the network protocol for extending a trust boundary between cloud domains of the same entity, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard. LTE Advanced. LTE Advanced Pro), a fifth generation wireless protocol (5G), and/or similar wired and/or wireless protocols, and may include one or more intermediary devices for routing data between the system 640 and the user devices 680A-680S.

Each user device 680A-680S (such as a desktop personal computer, workstation, laptop. Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684A-684S to interact with various GUI pages that may be presented to the one or more of users 684A-684S. User devices 680A-680S might communicate with system 640 using TCP/IP (Transfer Control Protocol and Internet Protocol) and, at a higher network level, use other networking protocols to communicate, such as Hypertext Transfer Protocol (HTTP). File Transfer Protocol (FTP). Andrew File System (AFS). Wireless Application Protocol (WAP). Network File System (NFS), an application program interface (API) based upon protocols such as Simple Object Access Protocol (SOAP). Representational State Transfer (REST), etc. In an example where HTTP is used, one or more user devices 680A-680S might include an HTTP client, commonly referred to as a “browser.” for sending and receiving HTTP messages to and from server(s) of system 640, thus allowing users 684A-684S of the user devices 680A-680S to access, process and view information, pages and applications available to it from system 640 over network 682.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation.” “an implementation.” “an example implementation.” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled.” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer system comprising:
a processor; and
memory coupled to the processor and storing instructions that, when executed by the processor, are configurable to cause the computer system to:
retrieve a message from a message queue, the message being associated with a hard real-time delivery constraint or a soft real-time delivery constraint; and
determine a current relevance of the message based on the message being associated with the soft real-time delivery constraint or the hard real-time delivery constraint; and
based on the determined current relevance of the message, either:
delete the message as being expired; or
encode the message for delivery to a user's computing device.

2. The computer system of claim 1, wherein the message is stored in the message queue in response to a hardware failure or network connection loss.

3. The computer system of claim 1, wherein the message is stored in the message queue in an indexed table.

4. The computer system of claim 3, wherein the memory further stores instructions to cause the computer system to delete a plurality of other messages from the indexed table as being expired based on the determined current relevance of the message.

5. The computer system of claim 1, wherein the message comprises metadata that includes an indicator of whether the message is associated with one or more of: the soft real-time delivery constraint, and the hard real-time delivery constraint.

6. The computer system of claim 5, wherein the metadata indicates the message is associated with the hard real-time delivery constraint and includes a timestamp after which the message is not relevant.

7. The computer system of claim 6, wherein the message is deleted as expired in response to a current time being after the timestamp.

8. The computer system of claim 6, wherein the message is encoded for transmission for delivery to the user's computing device in response to a current time being at or before the timestamp.

9. The computer system of claim 5, wherein the metadata indicates the message is associated with the soft real-time delivery constraint, and wherein the metadata further includes a timestamp and a time window associated with the timestamp beyond which the message is not relevant.

10. The computer system of claim 9, wherein the message is deleted as expired in response to a current time being beyond the time window.

11. The computer system of claim 9, wherein the message is encoded for transmission for delivery to the user's computing device in response to a current time being within the time window.

12. The computer system of claim 5, wherein the metadata indicates the message is associated with both the soft real-time delivery constraint and the hard real-time delivery constraint, wherein the metadata further includes a timestamp after which the message is not relevant relative to the hard real-time delivery constraint, wherein the metadata includes a time window associated with the timestamp, and wherein the message is not relevant relative to the soft real-time delivery constraint beyond the time window.

13. The computer system of claim 12, wherein the message is deleted as expired in response to a current time being both after the timestamp and beyond the time window.

14. The computer system of claim 12, wherein the message is encoded for transmission for delivery to the user's computing device in response to a current time being one or more of: at or before the timestamp, and within the time window.

15. The computer system of claim 1, wherein the computer system comprises a messaging system or portion thereof.

16. The computer system of claim 1, wherein the message includes an identifier associated with the user or the user's computing device.

17. The computer system of claim 1, wherein the message is encoded for delivery to the user's computing device via a messaging system.

18. The computer system of claim 1, wherein the message is encoded for transmission to the user's computing device via a messaging network.

19. A tangible, non-transitory computer-readable medium storing instructions that, when executed by a computer system, are configurable to cause the computer system to:
retrieve a message from a message queue, the message being associated with a hard real-time delivery constraint or a soft real-time delivery constraint; and
determine a current relevance of the message based on the message being associated with the soft real-time delivery constraint or the hard real-time delivery constraint; and
based on the determined current relevance of the message, either:
delete the message as being expired; or
encode the message for delivery to a user's computing device.

20. A method comprising:
retrieving a message from a message queue by a computer system, the message being associated with a hard real-time delivery constraint or a soft real-time delivery constraint; and
determining, by the computer system, a current relevance of the message based on the message being associated with the soft real-time delivery constraint or the hard real-time delivery constraint; and
based on the determined current relevance of the message, either:
deleting, by the computer system, the message as being expired; or
encoding, by the computer system, the message for delivery to a user's computing device.
